(19) United States
(12) Patent Application Publication
(10) Pub. No.: US 2009/0119368 A1
(43) Pub. Date: May 7, 2009

(54) SYSTEM AND METHOD FOR GATHERING CONVERSATION INFORMATION

(75) Inventors: Patrick Joseph O'Sullivan, Ballsbridge (IE); Robert Cameron Weir, Westford, MA (US); Edith Helen Stern, Yorktown Heights, NY (US); Barry E. Willner, Briarcliff Manor, NY (US)

Correspondence Address: HOLLAND & KNIGHT, 10 ST. JAMES AVENUE, BOSTON, MA, 02116-3889, US

(73) Assignee: INTERNATIONAL BUSINESS MACHINES CORPORATION, Armonk, NY (US)

(21) Appl. No.: 11/934,336

(22) Filed: Nov. 2, 2007

(51) Int. Cl. G06F 15/16

(52) U.S. Cl. 709/204

(57) ABSTRACT

A method and computer program product for receiving a request for conversation information, from a requester, concerning an online user of an instant messaging system. The conversation information concerning the online user is obtained and provided to the requestor.

### TECHNICAL FIELD

This disclosure relates to instant messaging systems and, more particularly, to gathering information concerning conversations occurring within instant messaging systems.

### BACKGROUND

Instant messaging provides real-time text based communication between two or more users interacting via computers or mobile devices. The more immediate and direct interaction provided by instant messaging often tends to more closely resemble a conversation, as compared to the more “letter like” format of email. The direct interaction between users may provide highly effective and convenient collaboration. For example, problems of unanswered emails and unreturned phone messages may be avoided.

Unfortunately, instant messaging conversations are not as easily joined as traditional conversations. For example, assume that three people are talking in the corridor. From a distance, a fourth person may see them, so that person may decide to walk over and join them in the conversation and make a contribution. That fourth person may have joined the conversation because they spotted the three people talking, or because the fourth person overheard something in passing. Either way, a social interaction took place that allowed the fourth person to join the other three people in conversation. Unfortunately, as instant messaging conversations are often private, the ability to “see” people involved in a conversation or overhear the topic of discussion does not exist. Accordingly, the opportunities to join an instant messaging conversation may not be as readily available as with those of traditional conversations.

### SUMMARY OF DISCLOSURE

In a first implementation, a method includes receiving a request for conversation information, from a requester, concerning an online user of an instant messaging system. The conversation information concerning the online user is obtained and provided to the requestor.

One or more of the following features may be included. The conversation information may include conversation duration information. Obtaining the conversation information may include determining the conversation duration information for a conversation in which the online user is participating. Providing the conversation information may include providing the conversation duration information to the requestor.

The conversation information may include conversation participant information. Obtaining the conversation information may include determining the conversation participant information for a conversation in which the online user is participating. Providing the conversation information may include providing the conversation participant information to the requestor.

The conversation information may include conversation topic information. Obtaining the conversation information may include determining the conversation topic information for a conversation in which the online user is participating. Providing the conversation information may include providing the conversation topic information to the requestor.

Determining the conversation topic information may include providing a chronological portion of the conversation to the requestor. Determining the conversation topic information may include providing one or more keywords concerning the conversation to the requestor. Determining the conversation topic information may include providing a summary of at least a portion of the conversation to the requestor.

In another implementation, a computer program product resides on a computer readable medium and has a plurality of instructions stored on it. When executed by a processor, the instructions cause the processor to perform operations including receiving a request for conversation information, from a requester, concerning an online user of an instant messaging system. The conversation information concerning the online user is obtained and provided to the requestor.

One or more of the following features may be included. The conversation information may include conversation duration information. Obtaining the conversation information may include determining the conversation duration information for a conversation in which the online user is participating. Providing the conversation information may include providing the conversation duration information to the requester.

The conversation information may include conversation participant information. Obtaining the conversation information may include determining the conversation participant information for a conversation in which the online user is participating. Providing the conversation information may include providing the conversation participant information to the requester.

The conversation information may include conversation topic information. Obtaining the conversation information may include determining the conversation topic information for a conversation in which the online user is participating. Providing the conversation information may include providing the conversation topic information to the requester.

Determining the conversation topic information may include providing a chronological portion of the conversation to the requester. Determining the conversation topic information may include providing one or more keywords concerning the conversation to the requester. Determining the conversation topic information may include providing a summary of at least a portion of the conversation to the requester.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of an information gathering process coupled to a distributed computing network;

FIG. 2 is a flowchart of the information gathering process of FIG. 1; and

FIG. 3 is a diagrammatic view of a display screen rendered, at least in part, by the information gathering process of FIG. 1.

Like reference symbols in the various drawings indicate like elements.

### DETAILED DESCRIPTION OF THE PREFERRED EMBODIMENTS

### System Overview:

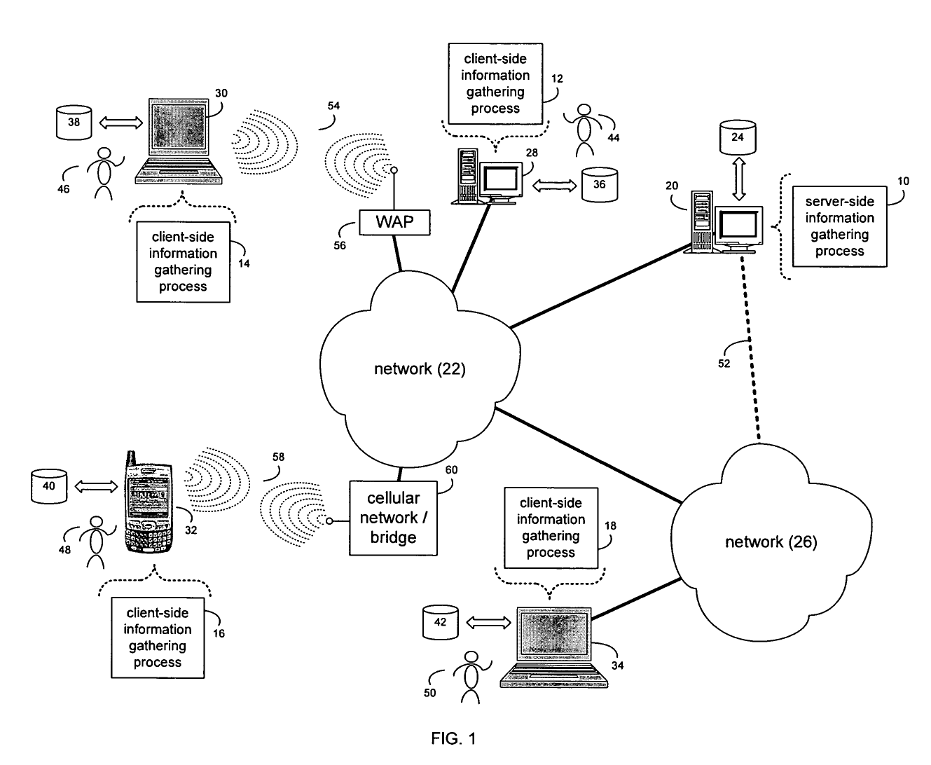

Referring to FIG. 1, there is shown an information gathering process 10. As will be discussed below, information gathering process 10 may receive a request for conversation information, from a requester, concerning an online user of an instant messaging system. The conversation information concerning the online user may be obtained and provided to the requestor. Accordingly, information gathering process 10 may allow for the gathering and dissemination of instant message conversation information in real time (or near real time), thus allowing the requester to make decisions concerning whether to join a conversation without having to e.g., make telephone calls or author email messages to the conversation participants.

The information gathering process may be a server-side process (e.g., server-side information gathering process 10), a client-side process (e.g., client-side information gathering process 12, client-side information gathering process 14, client-side information gathering process 16, or client-side information gathering process 18), or a hybrid server-side/client-side process (e.g., the combination of server-side information gathering process 10 and one or more of client-side information gathering processes 12, 14, 16, 18).

Server-side information gathering process 10 may reside on and may be executed by server computer 20, which may be connected to network 22 (e.g., the Internet or a local area network). Examples of server computer 20 may include, but are not limited to: a personal computer, a server computer, a series of server computers, a mini computer, and a mainframe computer. Server computer 20 may be a web server (or a series of servers) running a network operating system, examples of which may include but are not limited to: Microsoft Windows XP Server™; Novell Netware™; or Redhat Linux™, for example.

The instruction sets and subroutines of server-side information gathering process 10, which may be stored on storage device 24 coupled to server computer 20, may be executed by one or more processors (not shown) and one or more memory architectures (not shown) incorporated into server computer 20. Storage device 24 may include but is not limited to: a hard disk drive; a tape drive; an optical drive; a RAID array; a random access memory (RAM); and a read-only memory (ROM).

Server computer 20 may execute a web server application, examples of which may include but are not limited to: Microsoft IIS™, Novell Webserver™, or Apache Webserver™, that allows for access to server computer 20 (via network 22) using one or more protocols, examples of which may include but are not limited to HTTP (i.e., HyperText Transfer Protocol), SIP (i.e., session initiation protocol), and the Lotus Sametime™ VP protocol. Network 22 may be connected to one or more secondary networks (e.g., network 26), examples of which may include but are not limited to: a local area network; a wide area network; or an intranet, for example.

Client-side information gathering processes 12, 14, 16, 18 may reside on and may be executed by client electronic devices 28, 30, 32, 34 (respectively), examples of which may include but are not limited to personal computer 28, laptop computer 30, personal digital assistant 32, notebook computer 34, a data-enabled, cellular telephone (not shown), and a dedicated network device (not shown), for example. Client electronic devices 28, 30, 32, 34 may each be coupled to network 22 and/or network 26 and may each execute an operating system, examples of which may include but are not limited to Microsoft Windows™, Microsoft Windows CE™, Redhat Linux™, or a custom operating system.

The instruction sets and subroutines of client-side information gathering processes 12, 14, 16, 18, which may be stored on storage devices 36, 38, 40, 42 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Storage devices 36, 38, 40, 42 may include but are not limited to: hard disk drives; tape drives; optical drives; RAID arrays; random access memories (RAM); read-only memories (ROM); compact flash (CF) storage devices; secure digital (SD) storage devices; and memory stick storage devices.

Examples of client-side information gathering processes 12, 14, 16, 18 may include but are not limited to a process incorporated into and executed within a client-side instant messaging application (e.g., Microsoft IM™ and Lotus Sametime™), which allows for instant-message based communication between a plurality of users (e.g., users 46, 48). Examples of server-side information gathering process 10 may include a process incorporated into and executed within a server-side instant messaging application (e.g., Microsoft IM Server™ and Lotus Sametime Server™). Alternatively, client-side information gathering processes 12, 14, 16, 18 and/or server-side information gathering process 10 may be stand-alone applications that work in conjunction with (i.e., interface with) a client-side instant messaging application and/or a server-side instant messaging application (respectively). One or more of client-side information gathering processes 12, 14, 16, 18 and server-side information gathering process 10 may interface with each other (via network 22 and/or network 26) to allow a plurality of users (e.g., user 46, 48) to transmit instant messages to each other.

Users 44, 46, 48, 50 may access server-side information gathering process 10 directly through the device on which the client-side information gathering process (e.g., client-side information gathering processes 12, 14, 16, 18) is executed, namely client electronic devices 28, 30, 32, 34, for example. Users 44, 46, 48, 50 may access server-side information gathering process 10 directly through network 22 and/or through secondary network 26. Further, server computer 20 (i.e., the computer that executes server-side information gathering process 10) may be connected to network 22 through secondary network 26, as illustrated with phantom link line 52.

The various client electronic devices may be directly or indirectly coupled to network 22 (or network 26). For example, personal computer 28 is shown directly coupled to network 22 via a hardwired network connection. Further, notebook computer 34 is shown directly coupled to network 22 via a hardwired network connection. Laptop computer 30 is shown wirelessly coupled to network 22 via wireless communication channel 54 established between laptop computer 30 and wireless access point (i.e., WAP) 56, which is shown directly coupled to network 22. WAP 56 may be, for example, an IEEE 802.11a, 802.11b, 802.11g, Wi-Fi, and/or Bluetooth device that is capable of establishing wireless communication channel 54 between laptop computer 30 and WAP 56. Personal digital assistant 32 is shown wirelessly coupled to network 22 via wireless communication channel 58 established between personal digital assistant 32 and cellular network/bridge 60, which is shown directly coupled to network 22.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

### The Information Gathering Process:

For the following discussion, server-side information gathering process 10 is going to be described for illustrative purposes, in which client-side information gathering processes 12, 14, 16, 18 are processes incorporated into and executed within a client-side instant messaging application (e.g., Microsoft IM™ and Lotus Sametime™) that allow for communication with server-side information gathering process 10. However, this is not intended to be a limitation of this disclosure, as other configurations are possible (e.g., stand-alone, client-side information gathering processes and/or stand-alone server-side information gathering processes.

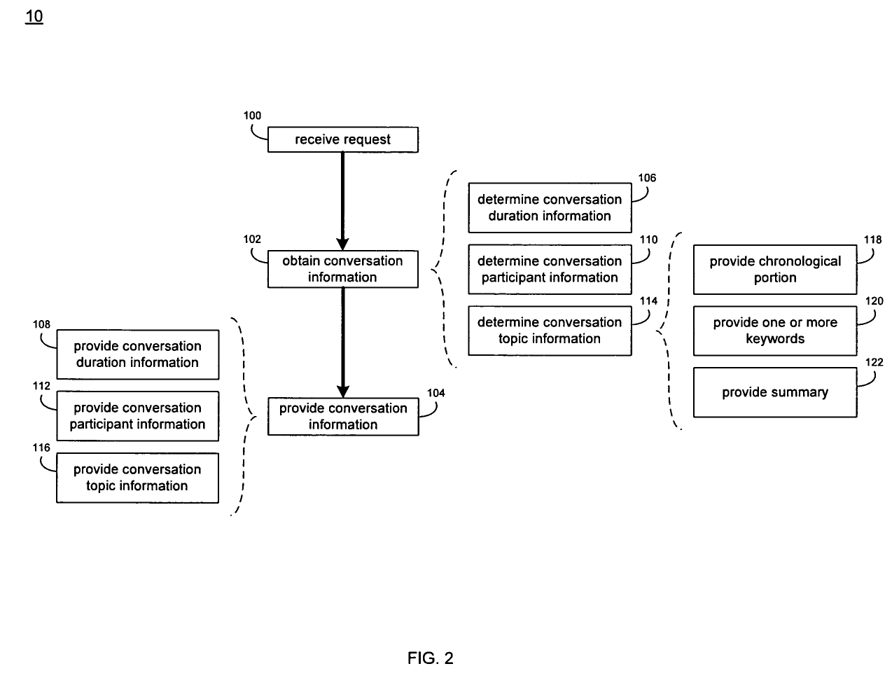

Referring also to FIG. 2, server-side information gathering process 10 may receive 100 a request for conversation information from a requester (e.g., user 44). This request received 100 may concern an online user (e.g., users 46, 50) of an instant messaging system. The conversation information concerning the online user (e.g., users 46, 50) may be obtained 102 and provided 104 to the requester (e.g., user 44).

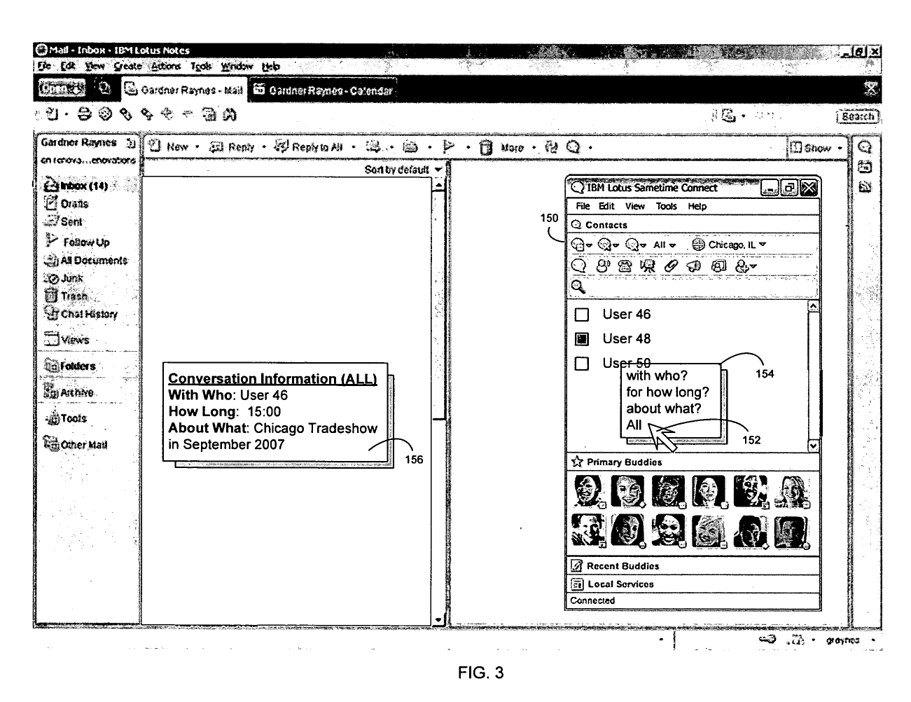

For example and referring also to FIG. 3, users 46, 50 are shown to be online within instant messaging user window 150. Further, user 48 is shown to be off-line. Assume for illustrative purposes that user 44, upon noticing that users 46, 50 are online, may be interested in joining an instant-messaging conversation being participated in by one or both of users 46, 50. Accordingly, user 44 may initiate a request for information concerning the conversations in which users 46, 50 are participating in.

Accordingly, user 44 may initiate a request by e.g. positioning onscreen pointer 152 (controllable by a pointing device such as a mouse, not shown) near the user symbol (e.g. a green square) and e.g. right-click the pointing device (not shown). Upon receiving 100 the request for conversation information from user 44, server-side information gathering process 10 may render pop-up window 154 that allows user 44 to select the particular type of conversation information they are interested in.

While pop-up window 154 rendered by server-side information gathering process 10 is shown to include four different types of available conversation information, namely “with who?”, “for how long?”, “about what?” and “all”, this is for illustrative purposes only and is not intended to be a limitation of disclosure as the actual number of types of available conversation information may vary depending upon e.g. user needs and design criteria.

If, when requesting conversation information, user 44 is interested in conversation participant information, user 44 may select “with who?” using onscreen pointer 152. If user 44 selects “with who?”, server-side information gathering process 10 may determine 110 the conversation participant information for the conversation in which the online user (e.g., user 50) is participating. For example and as discussed above, assume that user 50 is participating in instant messaging conversation with user 46. Upon determining 110 this conversation participant information, server-side information gathering process 10 may provide 112 the conversation participant information to the requester (e.g. user 44). When providing 112 the conversation participant information to the requestor, server-side information gathering process 10 may render pop-up information window 156 that defines the conversation participant information as “User 46”.

When determining 110 which users are participating within a conversation, information gathering process 10 may define time limits for making such a determination. For example, a participant of a conversation may be deemed a person who has contributed to the conversation within the last three minutes. Accordingly, assume that two other users (not shown) were initially engaged in a conversation with User 46 and User 50. However, further assume that neither of the two other users (not shown) has contributed to the conversation in at least twenty minutes, information gathering process 10 may not consider either of these two other users (not shown) to be participants within the above-described conversation. Additionally/alternatively, the level/position of the user may be taken into consideration when deciding whether a user is engaged in a conversation. For example, a high-level executive who has not participated in a conversation for twenty minutes may still be considered to be engaged in the conversation (for information gathering purposes) due to their high-level position within the company.

If, when requesting conversation information, user 44 is interested in conversation duration information, user 44 may select “for how long?” using onscreen pointer 152. If user 44 selects “for how long?”, server-side information gathering process 10 may determine 106 the conversation duration information for a conversation in which the online user (e.g. user 50) is participating. For example, assume that user 50 is participating in an instant messaging conversation with user 46, which has been taking place for 15:00 minutes. Upon determining 106 this conversation duration information, server-side information gathering process 10 may provide 108 the conversation duration information to the requester (e.g. user 44). When providing 108 user 44 with this conversation duration information, server-side information gathering process 10 may render a pop-up information window 156 that defines the conversation duration information as “15:00” minutes.

If, when requesting conversation information, user 44 is interested in conversation topic information, user 44 may select “about what?” using onscreen pointer 152. If user 44 selects “about what?”, server-side information gathering process 10 may determine 114 the conversation topic information for the conversation in which the online user (e.g. user 50) is participating. For example and as discussed above, assume that user 50 is participating in an instant messaging conversation with user 46. Further assume that this instant messaging conversation concerns an upcoming trade show in Chicago. Upon determining 114 this conversation topic information, server-side information gathering process 10 may provide 116 the conversation topic information to the requester (e.g. user 44). When providing 116 the conversation topic information to the requester, server-side information gathering process 10 may render a pop-up information window 156 that defines the conversation topic information as “Chicago Trade Show in September 2007”. Additionally, as an instant messaging conversation may have multiple topics, when providing 116 the conversation topic information to the requester, server-side information gathering process 10 may render a pop-up information window 156 that defines a plurality of topics.

Determining 114 the conversation topic information may include one or more of: providing 118 a chronological portion of the conversation to the requester; providing 120 one or more keywords concerning the conversation to the requester; and providing 122 a summary of at least a portion of the conversation to the requester.

Providing 118 a chronological portion of the conversation to the requester may include providing any portion of the text messages provided between users 46, 50 that may prove to be indicative of the topic of the conversation. For example, server-side information gathering process 10 may provide to user 46 the first e.g. four text messages passed between users 46, 50. For example, server-side information gathering process 10 may provide user 44 with the following information within pop-up information window 156:
User 46: Got a moment?
User 50: Sure . . . what's up?
User 46: Are you going to this Chicago Trade Show?
User 50: Yes I am . . . how about you?

Providing 120 one or more keywords concerning the conversation to the requester may include searching all or a portion of the text messages passed between users 46, 50 to extract pertinent keywords. For example, server-side information gathering process 10 may process all or a portion of the text messages passed between users 46, 50 to filter common words that do not substantively add to the conversation. For example, server-side information gathering process 10 may filter numerous generic words (examples of which may include but are not limited to: to; a; an; and; the; if; and then) to determine the topic of the conversation between users 46, 50. For example, server-side information gathering process 10 may provide user 44 with the following information within pop-up information window 156:
Chicago, Tradeshow, September

Providing 122 a summary of at least a portion of the conversation to the requestor may include processing all or a portion of the text messages passed between users 46, 50 to generate a summary of such messages. For example, server-side information gathering process 10 may include an automatic summarization process (not shown) that may process all or a portion of the text messages passed between users 46, 50 to automatically generate a summary of such messages. Alternatively, server-side information gathering process 10 may use an external automatic summarization process (e.g., Copernic Summarizer™) for processing and summarizing all or a portion of the text messages passed between users 46, 50. For example, server-side information gathering process 10 may provide user 44 with the following information within pop-up information window 156:
Chicago Tradeshow in September of 2007

If, when requesting conversation information, user 44 is interested in “all” conversation information, user 44 may select “All” using onscreen pointer 152. If user 44 selects “All”, server-side information gathering process 10 may determine 106 the conversation participant information, conversation duration information, and conversation topic information for the conversation in which the online user (e.g. user 50) is participating. For example, assume that user 50 is participating in an instant messaging conversation with user 46, which has been taking place for 15:00 minutes and concerns the topic “Chicago Tradeshow in September of 2007” (as summarized by the automatic summarization process discussed above). Upon determining 106 this conversation participant, duration and topic information, server-side information gathering process 10 may provide 108 the conversation participant, duration and topic information to the requestor (e.g. user 44). When providing 112, 108, 116 user 44 with this conversation participant, duration and topic information, server-side information gathering process 10 may render a pop-up information window 156 that defines the conversation participant, duration and topic information as “User 46”, “15:00” and “Chicago Tradeshow in September of 2007” (as illustrated within pop-up information window 156).

In addition to providing the user with summary information concerning an instant messaging conversation, information gathering process 10 may be configured to simply provide e.g., user 44 with an entire transcript of the complete instant messaging conversation. Accordingly if two users were engaged in a conversation for twenty minute, information gathering process 10 may be configured to provide the requestor with a transcript of the entire twenty minute conversation.

When information (e.g., participant information, duration information, and topic information) is provided to a requester, information gathering process 10 may allow the requester to save some or all of this information for subsequent retrieval and use.

The specific information available to a requester may vary depending on the rights of the requester. For example, a “super-user” may be allowed to see all information concerning any conversation (including the complete transcript), while a low-level user may only be allowed to see the participant information. Further, a senior user may have more rights than a junior user.

While the system is described above as requiring the user of the above-described system to right-click the pointing device (not shown), this is for illustrative purposes only and is not intended to be a limitation of this disclosure as other configurations are possible. For example, user 44 may simply allow onscreen pointer 152 to hover over a user symbol (e.g. a green square) associated with a user who may be participating in a conversation. A visual cue (not shown) may be rendered by server-side information gathering process 10 that allows e.g., user 44 to discern whether e.g., user 50 is currently involved in a conversation.

Additionally, while the system is described above as requiring the user to select the type of information that they are interested in, this is for illustrative purposes only, as other configurations are possible. For example, if user 50 is indeed involved in a conversation, server-side information gathering process 10 may automatically render pop-up information window 156 that defines all pertinent information (e.g., who user 50 is talking to, what they are talking about, how long they have been talking, etc.). If user 50 is participating in simultaneous, multiple independent conversations, multiple pop-up windows may be rendered (one for each conversation) or pop-up information window 156 may be sized to allow for the simultaneous display of information concerning all of the independent conversations.

When engaging in an instant messaging conversation, a user may define the conversation as “private” if they do not want to allow others to determine e.g., who they are talking to, how long they have been talking and what they are talking about. The manner in which a user may define a conversation as “private” may vary based upon e.g., the specific instant messaging program and the manner in which the program is implemented. For example, when engaged in a conversation, a user may open an options window (not shown) that may allow the user to define the conversation as private. Accordingly, when an instant messaging conversation is defined as private, server-side information gathering process 10 may not provide a requester with information concerning the conversation participants, the conversation duration, and the conversation topic. Accordingly, in the event that the requester right-clicks the pointing device (or hovers) over a user symbol of a user who is engaged in a private conversation, the requester may simply be provided with information concerning the private nature of the conversation.

A number of implementations have been described. Nevertheless, it will be understood that various modifications may be made. Accordingly, other implementations are within the scope of the following claims.

What is claimed is:

1. A method comprising:
receiving a request for conversation information, from a requester, concerning an online user of an instant messaging system;
obtaining the conversation information concerning the online user; and
providing the conversation information to the requestor.

2. The method of claim 1 wherein the conversation information includes conversation duration information.

3. The method of claim 2 wherein:
obtaining the conversation information includes determining the conversation duration information for a conversation in which the online user is participating; and
providing the conversation information includes providing the conversation duration information to the requestor.

4. The method of claim 1 wherein the conversation information includes conversation participant information.

5. The method of claim 4 wherein:
obtaining the conversation information includes determining the conversation participant information for a conversation in which the online user is participating; and
providing the conversation information includes providing the conversation participant information to the requestor.

6. The method of claim 1 wherein the conversation information includes conversation topic information.

7. The method of claim 6 wherein:
obtaining the conversation information includes determining the conversation topic information for a conversation in which the online user is participating; and
providing the conversation information includes providing the conversation topic information to the requestor.

8. The method of claim 7 wherein determining the conversation topic information includes:
providing a chronological portion of the conversation to the requestor.

9. The method of claim 7 wherein determining the conversation topic information includes:
providing one or more keywords concerning the conversation to the requestor.

10. The method of claim 7 wherein determining the conversation topic information includes:
providing a summary of at least a portion of the conversation to the requestor.

11. A method comprising:
receiving a request for conversation information, from a requester, concerning an online user of an instant messaging system;
obtaining the conversation information concerning the online user; and
providing the conversation information to the requestor.

12. The method of claim 11 wherein the conversation information includes conversation duration information.

13. The method of claim 12 wherein:
obtaining the conversation information includes determining the conversation duration information for a conversation in which the online user is participating; and
providing the conversation information includes providing the conversation duration information to the requestor.

14. The method of claim 11 wherein the conversation information includes conversation participant information.

15. The method of claim 14 wherein:
obtaining the conversation information includes determining the conversation participant information for a conversation in which the online user is participating; and
providing the conversation information includes providing the conversation participant information to the requestor.

16. The method of claim 11 wherein the conversation information includes conversation topic information.

17. The method of claim 16 wherein:
obtaining the conversation information includes determining the conversation topic information for a conversation in which the online user is participating; and
providing the conversation information includes providing the conversation topic information to the requestor.

18. The method of claim 17 wherein determining the conversation topic information includes:
providing a chronological portion of the conversation to the requestor.

19. The method of claim 17 wherein determining the conversation topic information includes:
providing one or more keywords concerning the conversation to the requestor.

20. The method of claim 17 wherein determining the conversation topic information includes:
providing a summary of at least a portion of the conversation to the requestor.
